(19) United States
(12) Patent Application Publication
(10) Pub. No.: US 2003/0214528 A1
(43) Pub. Date: Nov. 20, 2003

(54) Method for managing the annotation of documents

(75) Inventors: Jeffrey D. Pierce, Sandy Hook, CT (US); Richard D. Blue, Old Greenwich, CT (US); Lance Robinson, Mamaroneck, NY (US)

Correspondence Address: Pitney Bowes Inc., Intellectual Property & Technology Law Department, 35 Waterview Drive, P.O. Box 3000, Shelton, CT, 06484, US

(73) Assignee: Pitney Bowes Incorporated, Stamford, CT

(21) Appl. No.: 10/389,498

(22) Filed: Mar. 14, 2003

Related U.S. Application Data
(60) Provisional application No. 60/364,788, filed on Mar. 15, 2002.

(51) Int. Cl. H04N 7/14; G09G 5/00

(52) U.S. Cl. 345/723; 348/14.08

(57) ABSTRACT

A method that incorporates the recipients' comments to a document while providing an audit trail of the recipients' comments. An editor prepares an original draft document for comment. Then the editor electronically sends a copy of the original draft to the program, which identifies and registers the document to the program. Then the document is distributed to individual recipients. The individual recipients are requested to send their comments to the program, via email, fax or voicemail, etc. As commented documents are returned and registered to the editor, the comments on each page are identified and tied to the name of the recipient. The editor may now use the program to review the original document and all changes for each page, presented simultaneously by the program. All of the comments of all of the recipients may be presented simultaneously on one screen, allowing rapid comparison of comments and ensuring all comments about a page are seen at the same time.

This Application claims the benefit of the filing date of U.S. Provisional Application No. 60/364,788 filed Mar. 15, 2002, which is owned by the assignee of the present Application.

### FIELD OF INVENTION

This invention relates to methods for producing documents and, more particularly, to methods for managing the annotation of documents.

### BACKGROUND OF THE INVENTION

In many business situations, multiple individuals need to collaborate on the creation of a document. The document must go through several cycles of revisions during which a draft is circulated and comments, changes, and other input are sought from the recipients. The recipients may return the document with their comments, typically to an individual or sub-group acting as the ‘Editor’ charged with reconciling comments from all parties, making changes to the document and then circulating a new draft. This process of publishing a draft, circulating the draft, soliciting comments, and revising the draft is repeated until the document is deemed final.

Documents managed in this way include, but are not limited to: contracts; legal briefs; articles; books; speeches; reports; presentations; financial reports; disclosures; financial prospectuses; and sales, marketing and advertising materials, etc.

Computer software systems are typically used to edit and publish each revision of the document. Such systems include: word processor programs like Microsoft® Word® (hereinafter “Word”) manufactured by Microsoft Corporation of One Microsoft Way, Redmond, Wash. 98052, presentation management software programs like PowerPoint® manufactured by Microsoft Corporation of One Microsoft Way, Redmond, Wash. 98052.

Draft versions of documents may be distributed in one or more ways, including: on paper via the postal service, over night mail, courier, interoffice mail, hand-delivered, etc. Draft versions of documents may be distributed electronically, by facsimile, e-mail and/or, Internet-based collaboration systems.

Existing systems offer effective tools for the editor charged with the reconciliation of the parties' comments, as long as all comments are made ‘electronically’ as changes to the electronically distributed file, e.g., edits to a Word document, made within Word.

Features such as Word's “Track Changes” allow comments from one or more parties to be viewed simultaneously. The parties' comments may be reviewed, page-by-page, and edits made to create the next document version. Again, these systems only work if the comments are made as revisions to the electronically transmitted draft documents and returned electronically to the editor.

However, in many situations, the foregoing is not the case. Thus, the prior art does not offer effective solutions when any of the following occur: the digital document is printed and circulated in paper form, with comments made as hand-written annotations to the paper document (‘ink on paper’); the document is distributed digitally, but the recipient chooses to print out the document and make hand-written annotations, returning the marked-up paper copy, physically or through an image transmission system, such as facsimile; the recipient sends comments, not as part of the document, but as a point-by-point list of changes, for example in a short e-mail, i.e., on page 6, paragraph 4, change ‘would’ to - - - should - - - . One of the recipients may also wish to leave comments by phone, for example, as a voice mail message.

In all of the above situations, the prior art is unable to help the editor view and reconcile the recipient's comments. The editor currently has to resort to much more cumbersome and manual processes such as collecting or creating paper copies of all commented documents and laying them out in front of them and turning each copy to the same page and reviewing all comments on that page, jumping from document to document to identify alternative or conflicting input that they must reconcile.

Such a process is very cumbersome, time-consuming and error-prone when the number of recipients is more than a very small number. Also, the maintenance of an ‘audit’ trail that shows why a particular change was made is very difficult, i.e., what recipient made the comments. An audit trail may be very important in a complex editing process.

An additional disadvantage of the prior art is that Word's ‘track changes’ feature modifies the original document. Hence, it becomes difficult to read the document and to synchronize the comments made by multiple parties.

### SUMMARY OF THE INVENTION

This invention overcomes the disadvantages of the prior art by providing a method that incorporates the recipient's comments to a document while providing an audit trail of the recipient's comments. The foregoing is accomplished by having an editor prepare an original draft document for comment; having the editor electronically send a copy of the original draft to the Annotation Manager Program, which identifies and registers the document to the program; and/or distributes the document to individual recipient parties.

The recipient is requested to send his/her comments to the Annotation Manager Program, via email, fax or voicemail, or other communications method. If paper documents are returned, these documents are imaged (scanned) into the Annotation Manager Program. Recipient may also mark up a paper copy, scan it himself/herself, and transmit the resulting image file to the Annotation Manager Program.

As commented documents are registered to the Annotation Manager Program, the comments on each page are identified and tied to the name of the recipient party. The editor may now use the Annotation Manager Program to review the original document and all changes for each page, presented simultaneously by the Annotation Manager Program. Again, these changes may have been made in any of the following ways: edits to the electronic file, e.g., changes made in Word for windows and e-mailed back to the editor; changes made on paper with ink that are faxed or scanned into the system; and point-by-point comments in an email. Comments may also be made via voice mail. Voice mail comments are split into sections for each page to which they apply and can be played back as and when desired during the editing process from within the Annotation Manager Program.

Comments of all recipients may be presented simultaneously on one screen, allowing rapid comparison of comments and ensuring all comments about a page are seen at the same time. Comments from each recipient party are coded, e.g., by color, to aid identification of the source. Also, the comments by different recipients may be turned on or off as needed to allow a focus on different sources or to overcome physically overlapping annotations.

Printouts or image files may be made of the document with any or all comments displayed, either on top of the text, as made by the recipient party, or separated from the text, to allow comparison of many comments on the same section of text. This separated view is particularly useful to aid further negotiation of conflicting comments that may be necessary as part of the reconciliation process. The Annotation Manager Program may rapidly produce such ‘negotiation packs’, on paper or as image files.

### BRIEF DESCRIPTION OF THE DRAWINGS

FIG. 1 is a drawing of an original document;

FIG. 2 is a drawing of the original version of the document 10 shown in FIG. 1 that has been made available to a computer as an electronic formatted document 11 after at least one of the recipient's (Party 1) comments to the document have been received without any comments being displayed;

FIG. 3 is a drawing of the electronic version of the document shown in FIG. 2 with Party 1 comments displayed;

FIG. 4 is a drawing of the electronic version of the document shown in FIG. 2 with the comments received from Party 2 via paper scanned into a computer with the comments separated and overlaid on top of the electronic version of the document shown in FIG. 2;

FIG. 5 is a drawing of the electronic version of the document shown in FIG. 2 with the comments received from Party 3 via voice mail associated with their location in the electronic version of the document shown in FIG. 2;

FIG. 6 is a drawing of the electronic version of the document shown in FIG. 2 with the comments received from Party 4 via e-mail shown in the electronic version of the document;

FIG. 7 is a drawing of the electronic version of the document shown in FIG. 2 with Party 1, Party 2, Party 3 and Party 4 comments displayed;

FIG. 8 is a block diagram of an apparatus that may be used with this invention; and

FIG. 9 is a flow chart showing the process used by this invention.

### DETAILED DESCRIPTION OF THE PREFERRED EMBODIMENT

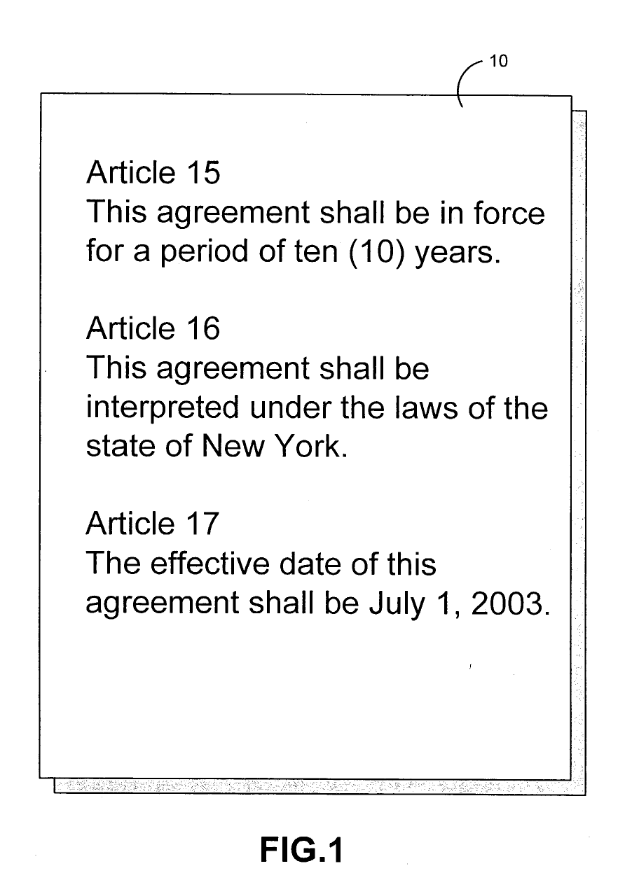

Referring now to the drawings in detail, and more particularly to FIG. 1, the reference character 10 represents an original document that is going to be sent to four recipients, i.e., Party 1, Party 2, Party 3 and Party 4.

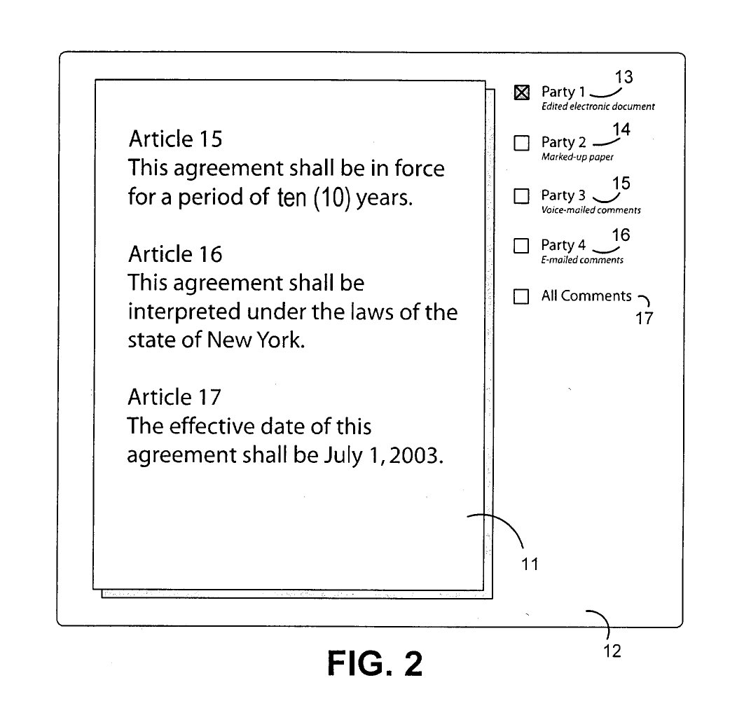

FIG. 2 is a drawing of the original version of the document 10 shown in FIG. 1 that has been made available to a computer as an electronic formatted document 11 after at least one of the recipients comments to the document have been received without any comments being displayed. Document 11 is viewed on computer display 12. Annotation viewing indicator 13 for Party 1 and annotation viewing indicator 14 for Party 2 appear on display 12. Annotation viewing indicator 15 for Party 3 and annotation viewing indicator 16 for Party 4 appear on display 12. All comments received indicator 17 also appears on display 12.

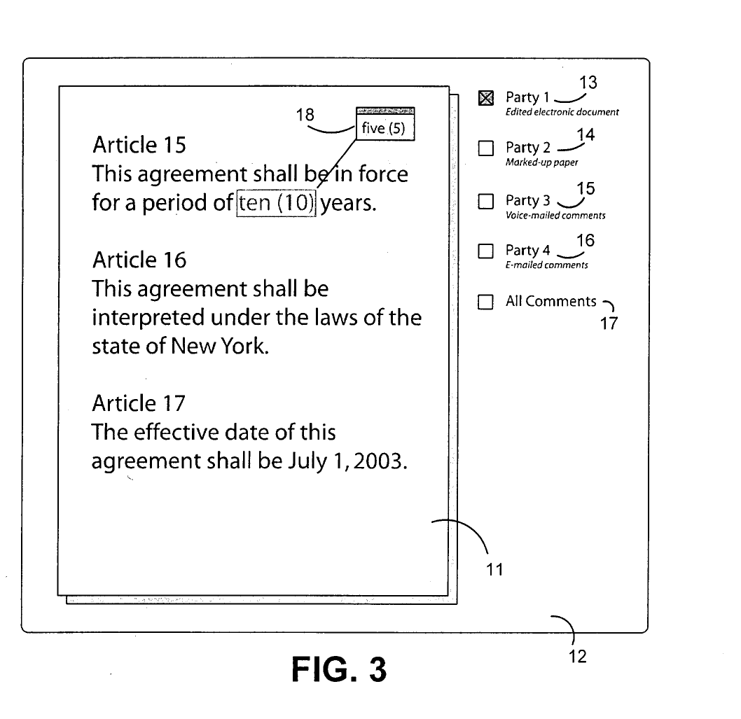

FIG. 3 is a drawing of the electronic version of the document 11 shown in FIG. 2 with Party 1 comments displayed on display 12 at space 18. Party 1 has electronically edited document 11, so indicator 13 is marked or highlighted and edited to indicate that Party 1 edited the electronic document 11.

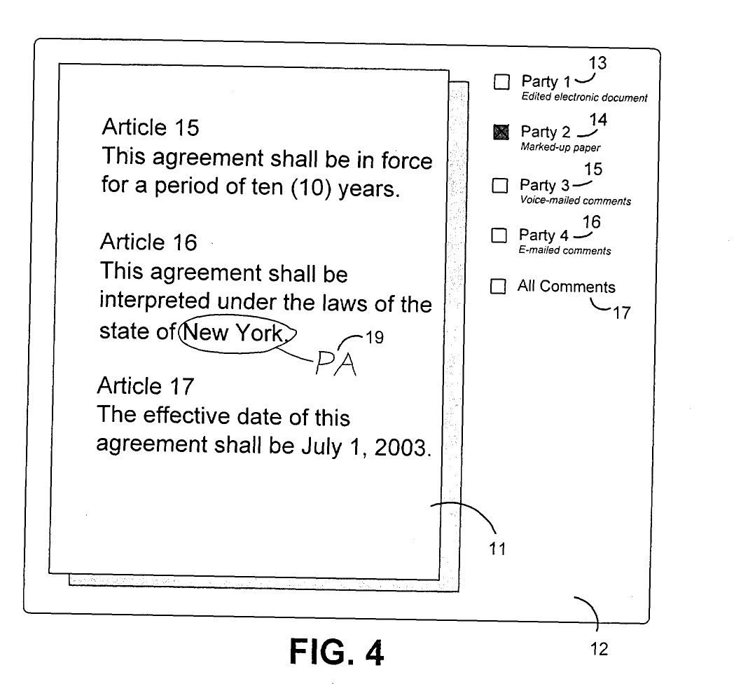

FIG. 4 is a drawing of the electronic version of the document 11 shown in FIG. 2 with the comments received from Party 2 via paper scanned into a computer with the comments space 19 separated and overlaid on top of the electronic version of the document shown in FIG. 2. Party 2 has marked up a paper version of document 11 so indicator 14 is marked or highlighted and edited to indicate that Party 2 edited a marked up paper version of the document.

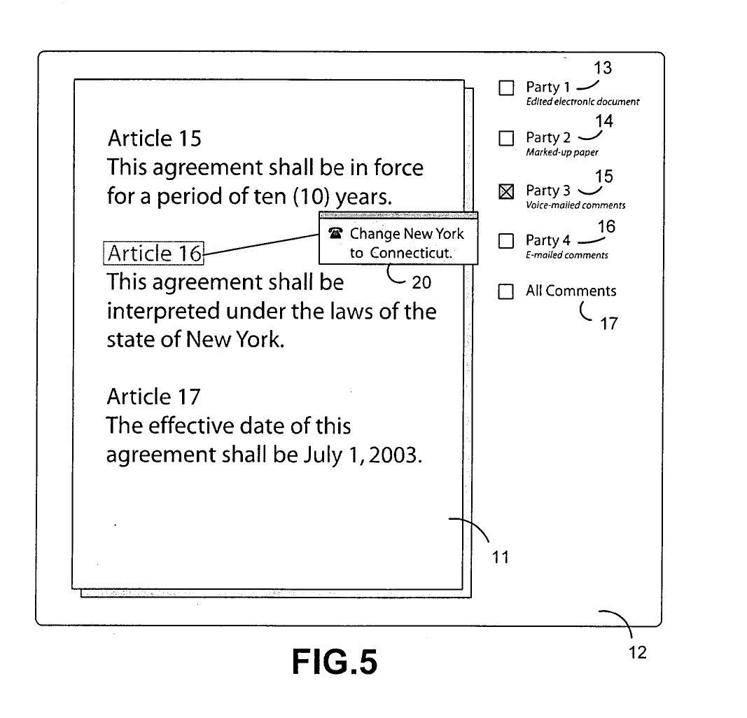

FIG. 5 is a drawing of the electronic version of the document shown in FIG. 2 with the comments in space 20 received from Party 3 via voice mail associated with their location in the electronic version of the document 11 shown in FIG. 2. Party 3 has submitted their comments, i.e., in Article 16 change New York to Connecticut, to document 11 via voice mail so indicator 15 is marked or highlighted and edited to indicate that Party 3's comments to the document were by voice mail.

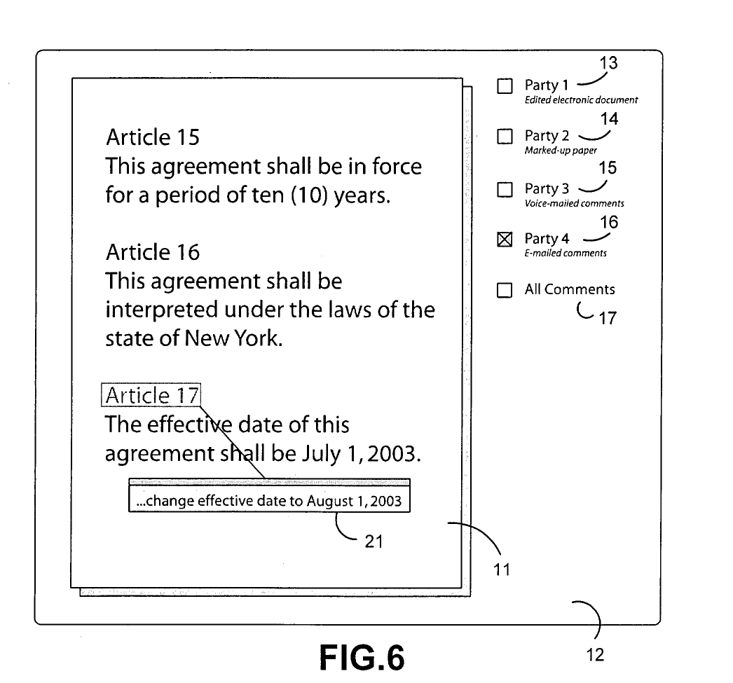

FIG. 6 is a drawing of the electronic version of the document 11 shown in FIG. 2 with the comments received from Party 4 via e-mail shown in the electronic version of the document 11. Party 4 has submitted their comments in space 21, i.e., in Article 17 change effective date to Aug. 1, 2003, document 11 via e-mail, so indicator 16 is marked or highlighted and edited to indicate that Party 4 e-mailed their comments.

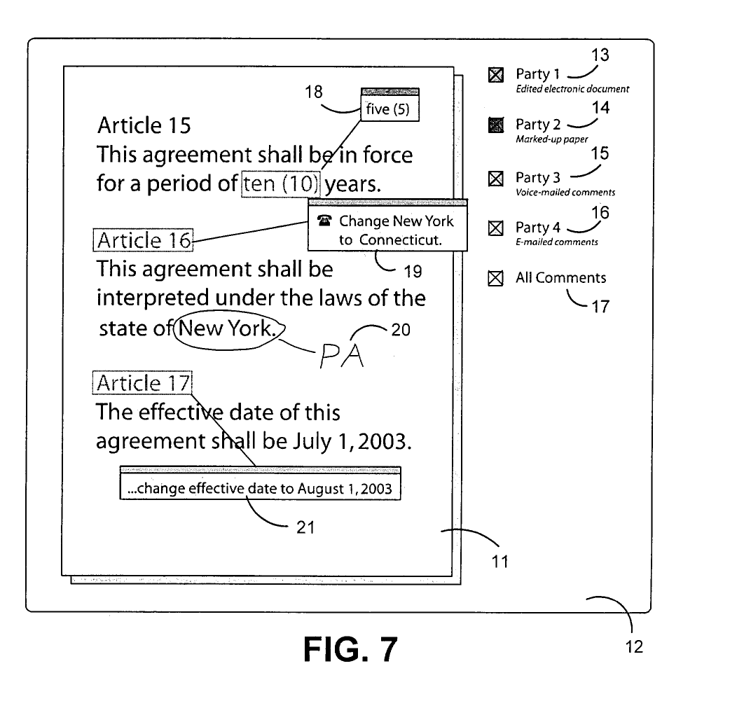

FIG. 7 is a drawing of the electronic version of the document shown in FIG. 2 with the comments or changes of Party 1, Party 2, Party 3 and Party 4, respectively, displayed at spaces 18-21.

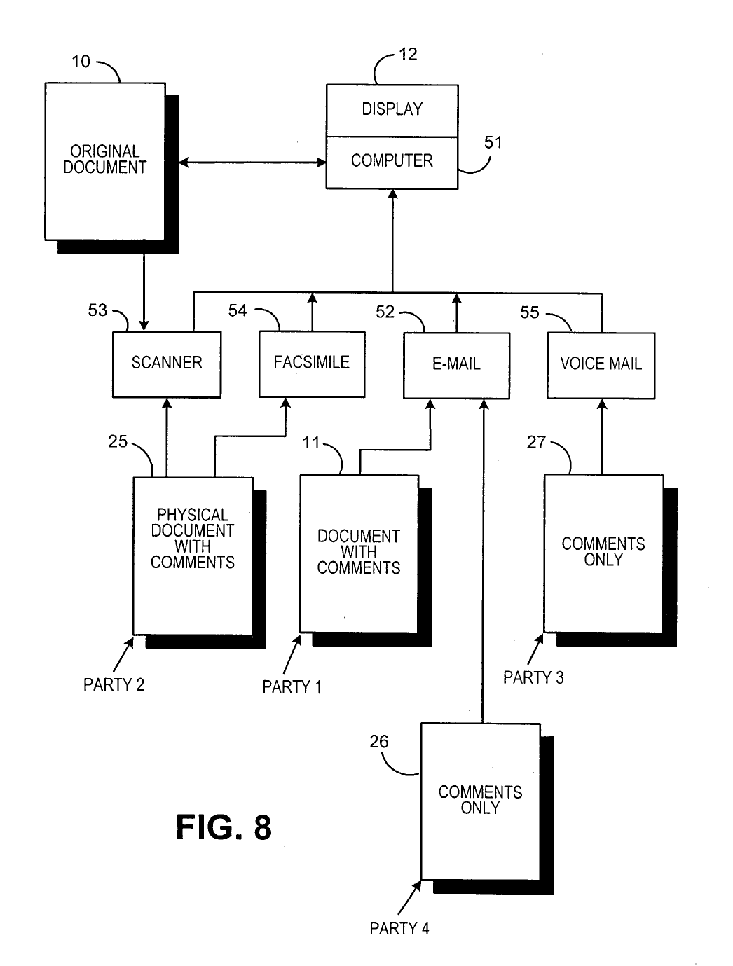

FIG. 8 is a block diagram of an apparatus that may be used with this invention. Original document 10 may be prepared with the aid of computer 51, or prepared with a different computer (not shown) and transmitted to computer 51 via e-mail 52, or scanned into scanner 53 and then transmitted into computer 51. Computer 51 will make an electronic image 11 (FIGS. 2-7) of document 10. Document 11 may be displayed on display 12. An electronic and/or a physical version of document 11 are delivered to Party 1, Party 2, Party 3 and Party 4. Party 1 may e-mail their comments regarding document 11 to computer 51 via email 52. Party 2 may have converted document 11 to a physical document 25 and placed their comments in document 25, or received physical document 25 and added their comments thereto before sending document 25 to computer 51 via facsimile 54. Party 2 may have converted document 11 to a physical document 25 and placed their comments in document 25, or received physical document 25 and added their comments thereto before sending document 25 to scanner 53, where document 53 is scanned into computer 51. Party 3 may send their comments 26 regarding document 11 to computer 51 via e-mail 52. Party 4 may send their comments 27 regarding document 11 to computer 51 via voice mail 55. Display 12 will display the information shown in FIG. 7.

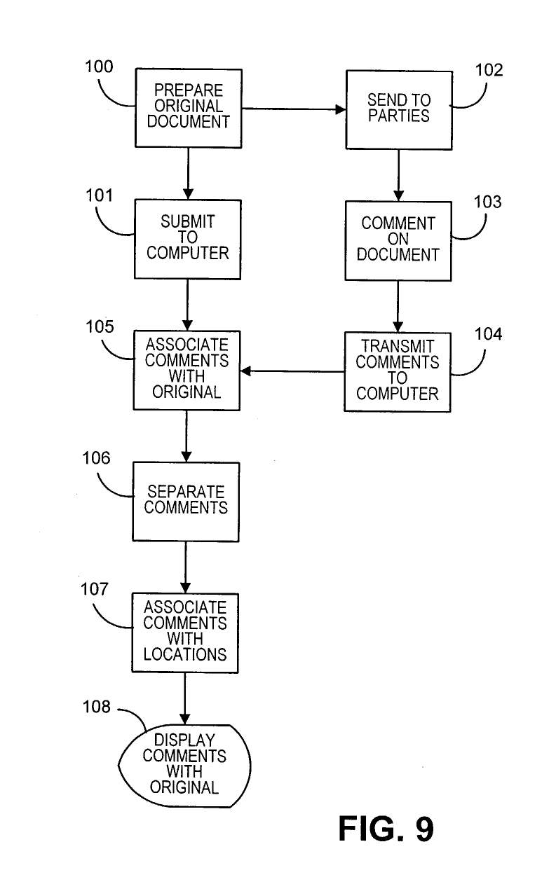

FIG. 9 is a flow chart showing the process used by this invention. The process begins at 100 where an original document is prepared. The next step is step 101 where the original version of the document becomes an electronic document in a computer. The next step is step 102 where the document in physical and/or electronic form is sent to recipients, i.e., Party 1, Party 2, Party 3 and Party 4. At this point in step 103, one or more of the recipients make comments on the document. In step 104, the recipient's comments are transmitted to a computer. Then in step 105, the recipient's comments are associated with the original document. Then in step 106, each of the recipients' comments are separated. Now in step 107, each recipient's comment is associated with a location in the original electronic version of the document. Next in step 108, a view is provided on computer display 12 of the original document with each of the recipients' comments relative to the locations in the original document without modifying the original document.

The above specification describes a new and improved method for annotating documents. It is realized that the above description may indicate to those skilled in the art additional ways in which the principles of this invention may be used without departing from the spirit. Therefore, it is intended that this invention be limited only by the scope of the appended claims.

What is claimed is:

1. A method for managing the annotation of a document that comprises the steps of:
a) preparing an original document;
b) making an original electronic version of the document available to a computer;
c) sending the document to recipients;
d) commenting on the document by one or more of the recipients who received the document;
e) transmitting the comments about the document to the computer by each of the recipients who commented on the document;
f) associating the comments with the original document;
g) separating each of the comments;
h) associating each comment with a location in the original electronic version of the document and
i) providing a view on a computer display of the original document with each of the recipients' comments relative to the locations in the original document without modifying the original document.

2. The method claimed in claim 1, wherein the transmitting step further includes the step of:
mailing the document containing a recipient's comments to the document to the computer via e-mail.

3. The method claimed in claim 2, further including the steps of:
a) comparing the original electronic version of the document with the original version of the document with comments; and
b) subtracting the original version of the document with the original version of the document with comments to obtain the comments and their location relative to the original document.

4. The method claimed in claim 1, wherein the transmitting step further includes the step of:
physically delivering the document with the recipient's comments to the computer.

5. The method claimed in claim 4, further including the step of:
imaging the delivered document to the computer; and
subtracting the original electronic document from the imaged document with comments to obtain the comments to the document.

6. The method claimed in claim 1, wherein the transmitting step further includes the step of:
sending comments to the document via voice mail.

7. The method claimed in claim 6, further including the steps of:
a) converting the voice comments to text comments; and
b) searching the text comments for their location in the original electronic document.

8. The method claimed in claim 1, further including the step of:
obtaining a physical copy of the view of the computer display.

9. The method claimed in claim 8, wherein the physical copy is a printed copy.

10. The method claimed in claim 9, wherein the original document is printed with the comments to the document printed on the same page as the original document.

11. The method claimed in claim 1, further including the steps of:
a) assembling a subset of the original document with comments; and
b) assembled subset to the parties.

12. The method claimed in claim 1, wherein the comments are modifications to the document.

13. The method claimed in claim 1, wherein the comments are explanations about portions of the document.

14. The method claimed in claim 1, wherein the comments are criticisms about portions of the document.

15. The method claimed in claim 1, wherein the comments are expressions of opinions about portions of the document.

16. The method claimed in claim 1, wherein the comments are additions to the document.
